(19) United States
(12) Patent Application Publication
(10) Pub. No.: US 2024/0142216 A1
(43) Pub. Date: May 2, 2024

(54) SENSOR UNIT

(71) Applicant: Murata Manufacturing Co., Ltd., Kyoto (JP)

(72) Inventors: Jun MAKINO, Kyoto (JP); Koji KAWANO, Kyoto (JP); Nobuyuki NOZAWA, Kyoto (JP); Tomoshige FURUHI, Kyoto (JP); Takashi WATANABE, Kyoto (JP); Takehiko IIZUKA, Kyoto (JP); Kenta AGO, Kyoto (JP)

(21) Appl. No.: 18/409,176

(22) Filed: Jan. 10, 2024

Related U.S. Application Data
(63) Continuation of application No. PCT/JP2022/021709, filed on May 27, 2022.

(30) Foreign Application Priority Data
Jul. 12, 2021 (JP) 2021-114731

(51) Int. Cl. G01B 7/16; A63B 60/46; A63F 13/211

(52) U.S. Cl. CPC G01B 7/16; A63B 60/46; A63F 13/211; A63B 2220/34; A63B 2220/44; A63B 2220/51; A63B 2220/62; A63B 2220/833

(57) ABSTRACT

A sensor unit includes: a sensor that is attached to a measurement target object becoming deformed in response to a swing taken with the measurement target object and that generates an output signal indicating a relationship between a physical quantity related to an amount of deformation of the measurement target object and a time; a feature value generation circuit that generates a feature value, the feature value being a parameter indicating a feature of the swing, on the basis of the output signal obtained by the sensor; and a communication unit that is attached to the measurement target object and that transmits the feature value to an external device by wireless communication or wired communication.

### CROSS REFERENCE TO RELATED APPLICATION

This is a continuation of International Application No. PCT/JP2022/021709 filed on May 27, 2022 which claims priority from Japanese Patent Application No. 2021-114731 filed on Jul. 12, 2021. The contents of these applications are incorporated herein by reference in their entireties.

### BACKGROUND OF THE DISCLOSURE

### Field of the Disclosure

The present disclosure relates to a sensor unit that is a sensor attached to a measurement target object that becomes deformed when swung, the sensor unit detecting a deformation of the measurement target object and generating an output signal.

### Description of the Related Art

As a disclosure related to a sensor unit in the related art, for example, a swing analysis apparatus, a swing analysis method, and a swing analysis system described in Patent Document 1 are known. The swing analysis apparatus described in Patent Document 1 includes an information input unit, an orientation calculation unit, a correction unit, and a display control unit. The information input unit accepts input of acceleration information, angular velocity information, and shaft distortion information detected by a sensor device attached to the shaft of a golf club. The orientation calculation unit calculates orientation information about the golf club during a swing period on the basis of the acceleration information and the angular velocity information. The correction unit corrects the orientation information about the golf club at the time of the impact on the basis of the shaft distortion information. The display control unit causes a display to display the orientation information about the golf club corrected by the correction unit. The swing analysis apparatus as described above can analyze the swing of the golf club.
Patent Document 1: Japanese Patent No. 6342034

### BRIEF SUMMARY OF THE DISCLOSURE

For the swing analysis apparatus described in Patent Document 1, there has been a demand for reducing the amount of data to be transmitted from the sensor device.

A possible benefit of the present disclosure is to provide a sensor unit that can attain a reduction in the amount of data to be transmitted.

A sensor unit according to an aspect of the present disclosure includes: a sensor that is attached to a measurement target object becoming deformed in response to a swing taken with the measurement target object and that generates an output signal indicating a relationship between a physical quantity related to an amount of deformation of the measurement target object and a time; a feature value generation circuit that generates a feature value, the feature value being a parameter indicating a feature of the swing, on the basis of the output signal obtained by the sensor; and a communication unit that is attached to the measurement target object and that transmits the feature value to an external device by wireless communication or wired communication.

The sensor unit according to the present disclosure can attain a reduction in the amount of data to be transmitted.

### BRIEF DESCRIPTION OF THE SEVERAL VIEWS OF THE DRAWINGS

FIG. 1 is a block diagram of a sensor unit 100 according to a first embodiment.

FIG. 2 is a diagram illustrating an example of a measurement target object 1 to which the sensor unit 100 is attached according to the first embodiment.

FIG. 3 includes a top view and a cross-sectional view of a sensor 10 according to the first embodiment.

FIG. 4 is a diagram illustrating an example of an output signal SigO that an AD converter 102 outputs to a feature value generation circuit 11 according to the first embodiment.

FIG. 5 is a flowchart illustrating a process performed by the feature value generation circuit 11 according to the first embodiment.

FIG. 6 is a diagram illustrating an example of the output signal SigO that the AD converter 102 outputs to the feature value generation circuit 11 according to a second embodiment.

FIG. 7 is a flowchart illustrating a process performed by the feature value generation circuit 11 according to the second embodiment.

FIG. 8 is a diagram illustrating an example of the output signal SigO that the AD converter 102 outputs to the feature value generation circuit 11 according to a third embodiment.

FIG. 9 is a flowchart illustrating a process performed by the feature value generation circuit 11 according to the third embodiment.

FIG. 10 is a block diagram of a sensor unit 100c according to a fourth embodiment.

FIG. 11 is a diagram illustrating an example of the output signal SigO that the AD converter 102 outputs to the feature value generation circuit 11 according to the fourth embodiment.

FIG. 12 is a flowchart illustrating a process performed by the feature value generation circuit 11 according to the fourth embodiment.

FIG. 13 includes a top view and a cross-sectional view of the sensor 10 according to a fifth embodiment.

FIG. 14 is a flowchart illustrating a process performed by the feature value generation circuit 11 according to the fifth embodiment.

FIG. 15 is a plan view of an example of a head 3 of the measurement target object 1 and a hit target object 4 at a hit time InT according to a sixth embodiment.

FIG. 16 is a plan view of an example of the head 3 of the measurement target object 1 and the hit target object 4 at the hit time InT according to the sixth embodiment.

FIG. 17 is a plan view of an example of the head 3 of the measurement target object 1 and the hit target object 4 at the hit time InT according to the sixth embodiment.

FIG. 18 is a flowchart illustrating a process performed by the feature value generation circuit 11 according to the sixth embodiment.

FIG. 19 is a flowchart illustrating a process performed by the feature value generation circuit 11 according to a seventh embodiment.

FIG. 20 is a flowchart illustrating a process performed by the feature value generation circuit 11 according to an eighth embodiment.

FIG. 21 is a flowchart illustrating a process performed by the feature value generation circuit 11 according to a ninth embodiment.

FIG. 22 is a flowchart illustrating a process performed by the feature value generation circuit 11 according to a tenth embodiment.

### DETAILED DESCRIPTION OF THE DISCLOSURE

### First Embodiment

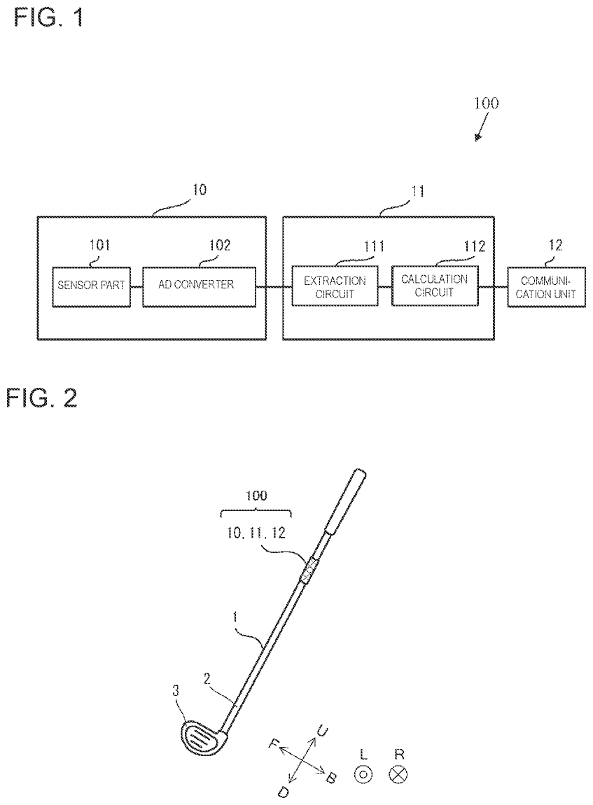

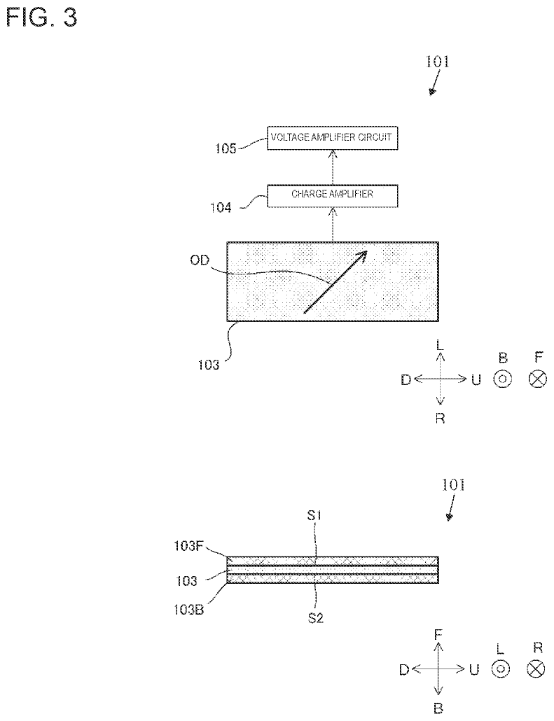

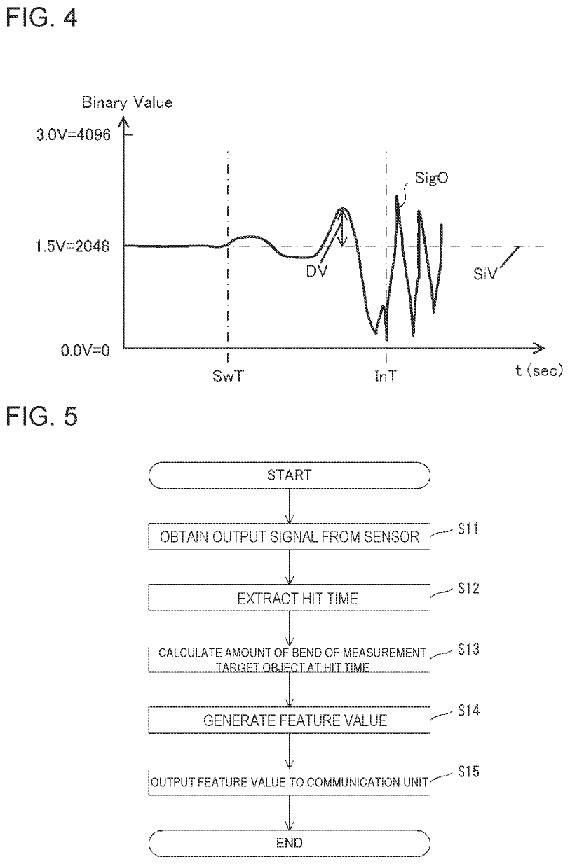

A sensor unit 100 according to a first embodiment of the present disclosure will be described below with reference to the figures. FIG. 1 is a block diagram of the sensor unit 100 according to the first embodiment. FIG. 2 is a diagram illustrating an example of a measurement target object 1 to which the sensor unit 100 is attached according to the first embodiment. FIG. 3 includes a top view and a cross-sectional view of a sensor 10 according to the first embodiment. FIG. 4 is a diagram illustrating an example of an output signal SigO that an AD converter 102 outputs to a feature value generation circuit 11 according to the first embodiment. FIG. 5 is a flowchart illustrating a process performed by the feature value generation circuit 11 according to the first embodiment.

In the specification, an axis or a member that extends in an upward-downward direction (first direction) is not necessary an axis or a member that is parallel to the upward-downward direction (first direction). An axis or a member that extends in the upward-downward direction (first direction) is an axis or a member that inclines relative to the upward-downward direction (first direction) within a range of ±45 degrees. Similarly, an axis or a member that extends in a front-back direction is an axis or a member that inclines relative to the front-back direction within a range of ±45 degrees. An axis or a member that extends in a rightward-leftward direction is an axis or a member that inclines relative to the rightward-leftward direction within a range of ±45 degrees.

In this embodiment, the upward-downward direction, the rightward-leftward direction, and the front-back direction are defined as illustrated in FIG. 2. More specifically, the direction in which a shaft 2 of the measurement target object 1 extends is defined as the upward-downward direction (first direction). The direction in which a head 3 of the measurement target object 1 points is defined as a leftward direction. The direction opposite to the leftward direction is a rightward direction. The front-back direction is defined as a direction orthogonal to the upward-downward direction and the rightward-leftward direction. Note that the upward-downward direction, the rightward-leftward direction, and the front-back direction when the measurement target object 1 is actually used need not coincide with the upward-downward direction, the rightward-leftward direction, and the front-back direction illustrated in FIG. 2.

In this embodiment, the measurement target object 1 is a member for hitting a hit target object 4. In this embodiment, the measurement target object 1 is a golf club. The hit target object 4 is a golf ball. The measurement target object 1 becomes deformed when swung. More specifically, the measurement target object 1 becomes deformed in response to a user swinging the measurement target object 1. When the user swings the measurement target object 1, the measurement target object 1 becomes deformed by inertial force and external force. The measurement target object 1 becomes deformed, for example, in the rightward-leftward direction at the time of the swing by the user. In this embodiment, the shape of the measurement target object 1 includes a shape that extends in the upward-downward direction (first direction).

As illustrated in FIG. 1, the sensor unit 100 includes the sensor 10, the feature value generation circuit 11, and a communication unit 12 (e.g., a transmitter). In this embodiment, the sensor 10, the feature value generation circuit 11, and the communication unit 12 are attached to the measurement target object 1. In this embodiment, the sensor 10, the feature value generation circuit 11, and the communication unit 12 are fixed to the shaft 2 of the measurement target object 1 as illustrated in FIG. 2.

The sensor 10 detects a deformation of the measurement target object 1. The sensor 10 generates an output signal indicating a relationship between the derivative value of the amount of deformation of the measurement target object 1 and the time. More specifically, the sensor 10 includes a sensor part 101 and the AD converter 102. The sensor part 101 includes a piezoelectric film 103, a first electrode 103F, a second electrode 103B, a charge amplifier 104, and a voltage amplifier circuit 105 as illustrated in FIG. 3. The piezoelectric film 103 generates a charge corresponding to the derivative value of the amount of deformation of the measurement target object 1.

The piezoelectric film 103 is an example of a piezoelectric body. The piezoelectric film 103 has a film shape. Therefore, the piezoelectric film 103 has a first main surface S1 and a second main surface S2 as illustrated in FIG. 3. In this embodiment, the first main surface S1 and the second main surface S2 have a rectangular shape when viewed in a direction normal to the first main surface S1 in a state in which the piezoelectric film 103 is spread on a plane. In this embodiment, the long-side direction of the piezoelectric film 103 is the upward-downward direction. The short-side direction of the piezoelectric film 103 is the rightward-leftward direction. In this embodiment, the piezoelectric film 103 is a PLA film.

The piezoelectric film 103 generates a charge corresponding to the derivative value of the amount of deformation of the piezoelectric film 103. The piezoelectric film 103 has a characteristic that the polarity of a charge generated in response to the piezoelectric film 103 being expanded in the upward-downward direction is opposite to that of a charge generated in response to the piezoelectric film 103 being expanded in the rightward-leftward direction. Specifically, the piezoelectric film 103 is a film formed of a chiral polymer. The chiral polymer is, for example, polylactic acid (PLA), specifically poly-L-lactic acid (PLLA). The main chain of PLLA formed of the chiral polymer has a helical structure. When uniaxially stretched to orient molecules, PLLA exhibits piezoelectricity. The piezoelectric film 103 has a piezoelectric constant of d14.

The uniaxial stretching axis OD of the piezoelectric film 103 forms an angle of 45 degrees counterclockwise relative to the upward-downward direction and forms an angle of 45 degrees clockwise relative to the rightward-leftward direction. That is, the piezoelectric film 103 is stretched in at least a uniaxial direction. The angle of 45 degrees includes, for example, an angle of about 45 degrees ±10 degrees. Accordingly, the piezoelectric film 103 generates a charge in response to the piezoelectric film 103 becoming deformed so as to be expanded in the upward-downward direction or becoming deformed so as to be contracted in the upward-downward direction. The piezoelectric film 103 generates, for example, a positive charge in response to the piezoelectric film 103 becoming deformed so as to be expanded in the upward-downward direction. The piezoelectric film 103 generates, for example, a negative charge in response to the piezoelectric film 103 becoming deformed so as to be contracted in the upward-downward direction. The magnitude of the charge depends on the derivative value of the amount of deformation of the piezoelectric film 103 caused by expansion or contraction.

The first electrode 103F is a ground electrode. The first electrode 103F is connected to a ground potential. The first electrode 103F is provided on the first main surface S1 as illustrated in FIG. 3. The first electrode 103F covers the first main surface S1. The first electrode 103F is, for example, an organic electrode formed of, for example, ITO (indium tin oxide) or ZnO (zinc oxide), a metal film formed by vapor deposition or plating, or a printed electrode film printed with a silver paste.

The second electrode 103B is a signal electrode. The second electrode 103B is provided on the second main surface S2 as illustrated in FIG. 3. The second electrode 103B covers the second main surface S2. The second electrode 103B is, for example, an organic electrode formed of, for example, ITO (indium tin oxide) or ZnO (zinc oxide), a metal film formed by vapor deposition or plating, or a printed electrode film printed with a silver paste. Accordingly, the piezoelectric film 103 is positioned between the first electrode 103F and the second electrode 103B.

The charge amplifier 104 converts the charge generated by the piezoelectric film 103 to a detection signal SigD, which is a voltage signal. For example, the charge amplifier 104 converts the charge to a voltage value within a range of 0.0 V to 3.0 V. After the conversion, the charge amplifier 104 outputs the detection signal SigD to the voltage amplifier circuit 105. The voltage amplifier circuit 105 amplifies the detection signal SigD and outputs the detection signal SigD to the AD converter 102.

The AD converter 102 performs AD conversion on the detection signal SigD. Accordingly, the AD converter 102 converts the detection signal SigD to a digital signal. Specifically, the AD converter 102 performs conversion on the detection signal SigD in accordance with the resolution of the AD converter 102. For example, when the AD converter 102 has a 12-bit resolution, the AD converter 102 converts the detection signal SigD to a binary value representing 4096 levels as illustrated in FIG. 4. The detection signal SigD that is converted to a digital signal is hereinafter referred to as the output signal SigO. The AD converter 102 obtains a reference voltage. The AD converter 102 sets a reference value SiV of the output signal SigO on the basis of the reference voltage. For example, the AD converter 102 sets a binary value 2048 as the reference value SiV as illustrated in FIG. 4. The AD converter 102 outputs the output signal SigO to the feature value generation circuit 11. That is, as illustrated in FIG. 4, the sensor 10 generates the output signal SigO that indicates a relationship between the derivative value of the amount of deformation of the measurement target object 1 and the time.

The sensor 10 as described above is fixed to the measurement target object 1 with a bonding layer (not illustrated) interposed therebetween. Specifically, the bonding layer is an insulating layer and fixes the measurement target object 1 and the first electrode 103F together.

The feature value generation circuit 11 includes an extraction circuit 111 and a calculation circuit 112 as illustrated in FIG. 1. The feature value generation circuit 11 generates a feature value F, which is a parameter indicating features of the swing, on the basis of the output signal SigO obtained by the sensor 10. In this embodiment, the feature value generation circuit 11 generates the feature value F by performing an extraction process on the basis of the output signal SigO. For example, as illustrated in FIG. 4, a hit time InT, which is the time when the measurement target object 1 hits the hit target object 4, or a swing start time SwT, which is the time when the user starts swinging the measurement target object 1, is a specific time. In this embodiment, the specific time that the feature value generation circuit 11 extracts on the basis of the output signal SigO is the hit time InT. The feature value F includes the hit time InT.

The amount of deformation of the measurement target object 1 in the rightward-leftward direction is proportional to a force FRL1 applied to the measurement target object 1 in the rightward-leftward direction when the user swings the measurement target object 1. That is, a value obtained by integrating a value DV, which is the result of subtracting the reference value SiV from the output signal SigO, with the time is proportional to the force FRL1 applied to the measurement target object 1 in the rightward-leftward direction when the user swings the measurement target object 1. Accordingly, the output signal SigO indirectly indicates the force FRL1 applied to the measurement target object 1 in the rightward-leftward direction when the user swings the measurement target object 1. At the moment when the measurement target object 1 hits the hit target object 4, the magnitude of the amount of deformation of the measurement target object 1 sharply increases. In other words, at the moment when the measurement target object 1 hits the hit target object 4, the derivative value of the amount of deformation of the measurement target object 1 becomes a local maximum or a local minimum. The feature value generation circuit 11 can obtain the hit time InT by detecting the maximum value among local maxima of the output signal SigO in a specific period or the minimum value among local minima thereof. Accordingly, the feature value generation circuit 11 can extract the hit time InT on the basis of the output signal SigO.

The output signal SigO is a value corresponding to the derivative value of the amount of deformation of the measurement target object 1 in the rightward-leftward direction. For example, when the measurement target object 1 bends in the rightward-leftward direction, the measurement target object 1 expands and contracts in the upward-downward direction. Therefore, the piezoelectric film 103 expands and contracts in the upward-downward direction. As a result, the piezoelectric film 103 generates a charge. In this embodiment, the piezoelectric film 103 generates a positive charge when a bend of the measurement target object 1 in the rightward direction increases. The piezoelectric film 103 generates a negative charge when a bend of the measurement target object 1 in the leftward direction increases. The measurement target object 1 becomes elastically deformed. In other words, the measurement target object 1 bends. Therefore, a value obtained by integrating the derivative value of the amount of deformation of the measurement target object 1 in the rightward-leftward direction with the time is the amount of bend B of the measurement target object 1 in the rightward-leftward direction at the specific time. That is, the output signal SigO indirectly indicates the amount of bend B of the measurement target object 1 in the rightward-leftward direction at the specific time. More specifically, the value DV, which is the result of subtracting the reference value SiV from the output signal SigO, being positive indicates that the amount of bend B of the measurement target object 1 in the rightward direction increases (the amount of bend B in the leftward direction decreases), and the value DV, which is the result of subtracting the reference value SiV from the output signal SigO, being negative indicates that the amount of bend B of the measurement target object 1 in the rightward direction decreases (the amount of bend B in the leftward direction increases). Therefore, the feature value generation circuit 11 can calculate the amount of bend B of the measurement target object 1 in the rightward-leftward direction at the specific time by integrating the value DV, which is the result of subtracting the reference value SiV from the output signal SigO, with the time. Accordingly, the feature value generation circuit 11 can calculate the amount of bend B of the measurement target object 1 at the specific time on the basis of the output signal SigO. In this embodiment, the feature value generation circuit 11 generates the feature value F by performing a calculation process on the basis of the output signal SigO. The feature value generation circuit 11 calculates the amount of bend B of the measurement target object 1 at the hit time InT on the basis of the output signal SigO. The feature value F includes the amount of bend B of the measurement target object 1 at the hit time InT.

The extraction circuit 111 stores a program for the process of extracting the hit time InT on the basis of the output signal SigO. The extraction circuit 111 includes, for example, a ROM (read-only memory) and a RAM (random access memory). The extraction circuit 111 loads the program stored in the ROM to the RAM. Accordingly, the extraction circuit 111 performs the process of extracting the hit time InT on the basis of the output signal SigO. The extraction circuit 111 as described above is, for example, a CPU (central processing unit).

The calculation circuit 112 stores a program for the process of calculating the amount of bend B of the measurement target object 1 at the hit time InT on the basis of the output signal SigO. The calculation circuit 112 includes, for example, a ROM (read-only memory) and a RAM (random access memory). The calculation circuit 112 loads the program stored in the ROM to the RAM. Accordingly, the calculation circuit 112 performs the process of calculating the amount of bend B of the measurement target object 1 at the hit time InT on the basis of the output signal SigO. The calculation circuit 112 as described above is, for example, a CPU (central processing unit). The extraction circuit 111 and the calculation circuit 112 may be formed of the same CPU or different CPUs.

A process performed in the feature value generation circuit 11 in relation to extraction of the hit time InT and calculation of the amount of bend B of the measurement target object 1 at the hit time InT will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S11 in FIG. 5).

Next, the extraction circuit 111 extracts the hit time InT (step S12 in FIG. 5). The feature value generation circuit 11 determines, for example, the time when the absolute value of the value DV, which is the result of subtracting the reference value SiV from the output signal SigO, becomes maximum to be the hit time InT.

Next, the calculation circuit 112 calculates the amount of bend B of the measurement target object 1 at the hit time InT (step S13 in FIG. 5). More specifically, the calculation circuit 112 calculates the amount of bend B of the measurement target object 1 at the hit time InT by integrating the value DV, which is the result of subtracting the reference value SiV from the output signal SigO, with a period from the time when the sensor 10 starts detection to the hit time InT.

Next, the feature value generation circuit 11 generates the feature value F on the basis of the hit time InT extracted by the extraction circuit 111 and the amount of bend B of the measurement target object 1 at the hit time InT, the amount of bend B being calculated by the calculation circuit 112 (step S14 in FIG. 5).

Next, the feature value generation circuit 11 outputs the feature value F to the communication unit 12 (step S15 in FIG. 5).

The amount of data of the hit time InT and the amount of bend B of the measurement target object 1 at the hit time InT is smaller than the amount of data of the output signal SigO. In other words, the amount of data of the feature value F is smaller than the amount of data of the output signal SigO. More specifically, as illustrated in FIG. 4, data of the output signal SigO includes a plurality of times and signals at the plurality of times while data of the hit time InT and the amount of bend B of the measurement target object 1 at the hit time InT includes at least any of one time or a signal at the one time, and therefore, the amount of data of the feature value F is smaller than the amount of data of the output signal SigO.

The communication unit 12 transmits the hit time InT and the amount of bend B of the measurement target object 1 at the hit time InT to an external device by wireless communication. In other words, the communication unit 12 transmits the feature value F to an external device by wireless communication. The external device is, for example, a portable wireless communication terminal, such as a smartphone. The wireless communication is, for example, communication using Bluetooth (registered trademark).

(Effects)

The sensor unit 100 can attain a reduction in the amount of data to be transmitted. More specifically, the sensor 10 generates the output signal SigO, which indicates a relationship between a physical quantity related to the amount of deformation of the measurement target object 1 and the time. The output signal SigO is inputted to the feature value generation circuit 11. The feature value generation circuit 11 generates the feature value F, which is a parameter indicating features of the swing, on the basis of the output signal SigO. Accordingly, data of the output signal SigO includes a plurality of times and signals at the plurality of times while data of the feature value F includes at least any of one time or a signal at the one time. Therefore, the amount of data of the feature value F is smaller than the amount of data of the output signal SigO. As a result, the sensor unit 100 can attain a reduction in the amount of data to be transmitted.

In the sensor unit 100, the feature value generation circuit 11 generates the feature value F by performing the extraction process on the basis of the output signal SigO. As a result, the sensor unit 100 can attain a reduction in the amount of data to be transmitted.

In the sensor unit 100, the feature value generation circuit 11 extracts the hit time InT when the measurement target object 1 hits the hit target object 4, on the basis of the output signal SigO. The feature value F includes the hit time InT. As a result, the sensor unit 100 can attain a reduction in the amount of data to be transmitted and can transmit the hit time InT to an external device.

In the sensor unit 100, the feature value generation circuit 11 generates the feature value F by performing the calculation process on the basis of the output signal SigO. As a result, the sensor unit 100 can attain a reduction in the amount of data to be transmitted.

In the sensor unit 100, the feature value generation circuit 11 calculates the amount of bend B of the measurement target object 1 at the specific time on the basis of the output signal SigO. The feature value F includes the amount of bend B of the measurement target object 1 at the specific time. As a result, the sensor unit 100 can attain a reduction in the amount of data to be transmitted and can transmit the amount of bend B of the measurement target object 1 at the specific time to an external device.

### Second Embodiment

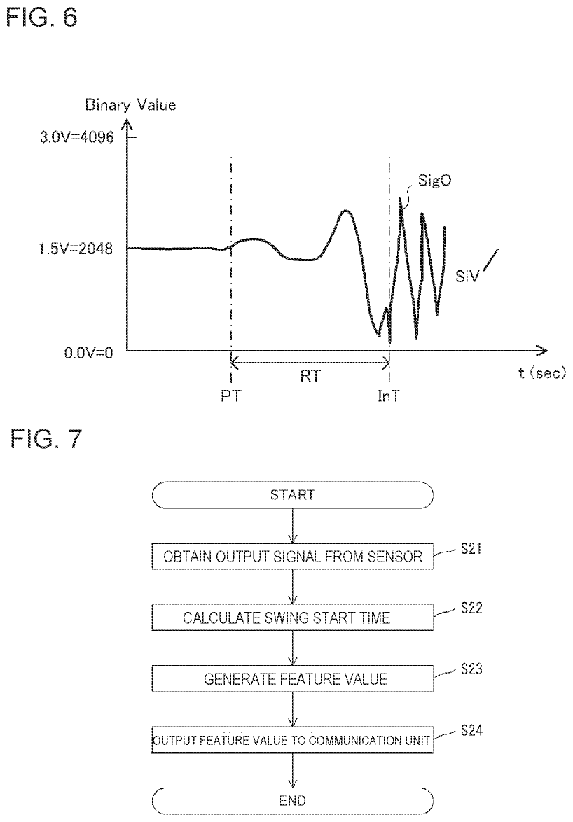

A sensor unit 100a according to a second embodiment of the present disclosure will be described below with reference to the figures. FIG. 6 is a diagram illustrating an example of the output signal SigO that the AD converter 102 outputs to the feature value generation circuit 11 according to the second embodiment. FIG. 7 is a flowchart illustrating a process performed by the feature value generation circuit 11 according to the second embodiment. Regarding the sensor unit 100a according to the second embodiment, a description of only the differences from the sensor unit 100 according to the first embodiment will be given and a description of the rest will be omitted.

In this embodiment, the feature value generation circuit 11 calculates the swing start time SwT on the basis of the output signal SigO. The feature value F includes the swing start time SwT.

As described above, the output signal SigO indirectly indicates the force FRL1 applied to the measurement target object 1 in the rightward-leftward direction when the user swings the measurement target object 1. Accordingly, the hit time InT can be extracted on the basis of the output signal SigO to calculate the swing start time SwT, which is the time when the user starts swinging the measurement target object 1. For example, the swing start time SwT can be presumed to be a past time earlier than the hit time InT.

The extraction circuit 111 and the calculation circuit 112 store a program for a process of calculating the swing start time SwT on the basis of the output signal SigO. A process performed in the feature value generation circuit 11 in relation to calculation of the swing start time SwT will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S21 in FIG. 7).

Next, the calculation circuit 112 calculates the swing start time SwT on the basis of the output signal SigO (step S22 in FIG. 7). More specifically, the swing start time SwT is a past time PT earlier than the hit time InT by a reference time RE as illustrated in FIG. 6. The reference time RE is set in advance to, for example, 0.2 seconds or 0.3 seconds.

Next, the feature value generation circuit 11 generates the feature value F on the basis of the swing start time SwT calculated by the calculation circuit 112 (step S23 in FIG. 7).

Next, the feature value generation circuit 11 outputs the feature value F to the communication unit 12 (step S24 in FIG. 7).

The sensor unit 100a as described above also attains an effect that is the same as the effect attained by the sensor unit 100. In the sensor unit 100a, the feature value generation circuit 11 calculates the swing start time SwT on the basis of the output signal SigO. The feature value F includes the swing start time SwT. As a result, the sensor unit 100a can transmit the swing start time SwT to an external device.

### Third Embodiment

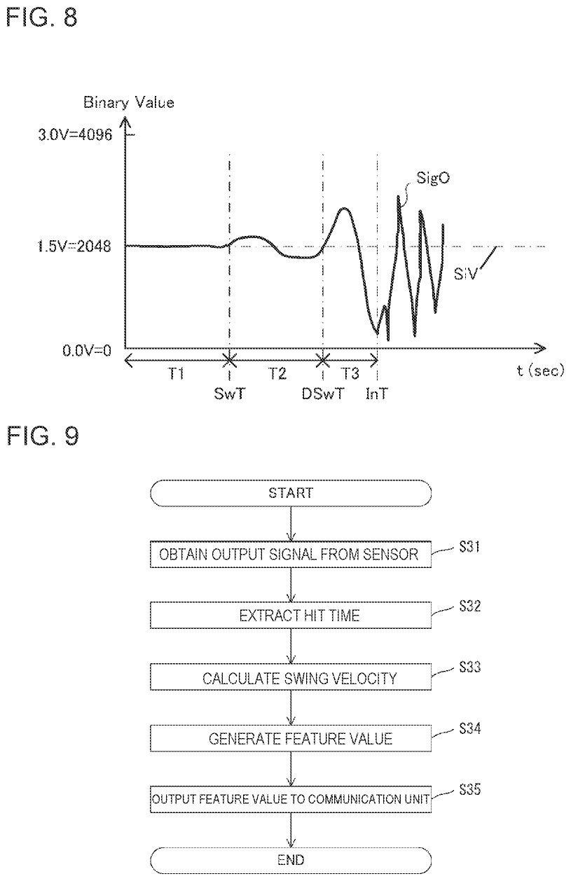

A sensor unit 100b according to a third embodiment of the present disclosure will be described below with reference to the figures. FIG. 8 is a diagram illustrating an example of the output signal SigO that the AD converter 102 outputs to the feature value generation circuit 11 according to the third embodiment. FIG. 9 is a flowchart illustrating a process performed by the feature value generation circuit 11 according to the third embodiment. Regarding the sensor unit 100b according to the third embodiment, a description of only the differences from the sensor unit 100 according to the first embodiment will be given and a description of the rest will be omitted.

In this embodiment, the feature value generation circuit 11 calculates a swing velocity SwV at the specific time on the basis of the output signal SigO. The feature value F includes the swing velocity SwV at the specific time.

A value obtained by performing second-order integration on the derivative value of the amount of deformation of the measurement target object 1 in the rightward-leftward direction with the time is proportional to the velocity of the measurement target object 1 in the rightward-leftward direction at the specific time. That is, the output signal SigO indirectly indicates the swing velocity SwV of the measurement target object 1 at the specific time. More specifically, as illustrated in FIG. 8, during a first period T1 from the time when the sensor 10 starts detection to the swing start time SwT, the value DV, which is the result of subtracting the reference value SiV from the output signal SigO, is approximately zero, and a value obtained by performing second-order integration on the value DV, which is the result of subtracting the reference value SiV from the output signal SigO, with the time is approximately zero. That is, during the first period T1 from the time when the sensor 10 starts detection to the swing start time SwT, the swing velocity SwV is also approximately zero. During a second period T2 from the swing start time SwT to a downswing start time DSwT, the output signal SigO starts gradually increasing from the reference value SiV immediately after the swing start time SwT and subsequently decreases. At the downswing start time DSwT, a value obtained by performing second-order integration on the value DV, which is the result of subtracting the reference value SiV from the output signal SigO, with the time is approximately zero, and the swing velocity SwV is also approximately zero. During a third period T3 from the downswing start time DSwT to the hit time InT, the output signal SigO starts sharply increasing from the reference value SiV immediately after the downswing start time DSwT and subsequently decreases sharply. At the hit time InT, the output signal SigO becomes a local minimum. Accordingly, the feature value generation circuit 11 can calculate the swing velocity SwV at the specific time on the basis of the output signal SigO. In this embodiment, the feature value generation circuit 11 calculates the swing velocity SwV at the hit time InT on the basis of the output signal SigO.

The extraction circuit 111 and the calculation circuit 112 store a program for a process of calculating the swing velocity SwV at the hit time InT on the basis of the output signal SigO. A process performed in the feature value generation circuit 11 in relation to calculation of the swing velocity SwV at the hit time InT will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S31 in FIG. 9).

Next, the extraction circuit 111 extracts the hit time InT (step S32 in FIG. 9).

Next, the calculation circuit 112 calculates the swing velocity SwV at the hit time InT on the basis of the output signal SigO (step S33 in FIG. 9). More specifically, the calculation circuit 112 calculates the swing velocity SwV at the hit time InT by performing second-order integration on the value DV, which is the result of subtracting the reference value SiV from the output signal SigO, with the period from the time when the sensor 10 starts detection to the hit time InT.

Next, the feature value generation circuit 11 generates the feature value F on the basis of the swing velocity SwV at the hit time InT calculated by the calculation circuit 112 (step S34 in FIG. 9).

Next, the feature value generation circuit 11 outputs the feature value F to the communication unit 12 (step S35 in FIG. 9).

The sensor unit 100b as described above also attains an effect that is the same as the effect attained by the sensor unit 100a. In the sensor unit 100b, the feature value generation circuit 11 calculates the swing velocity SwV at the specific time on the basis of the output signal SigO. The feature value F includes the swing velocity SwV at the specific time. As a result, the sensor unit 100a can transmit the swing velocity SwV at the specific time to an external device.

### Fourth Embodiment

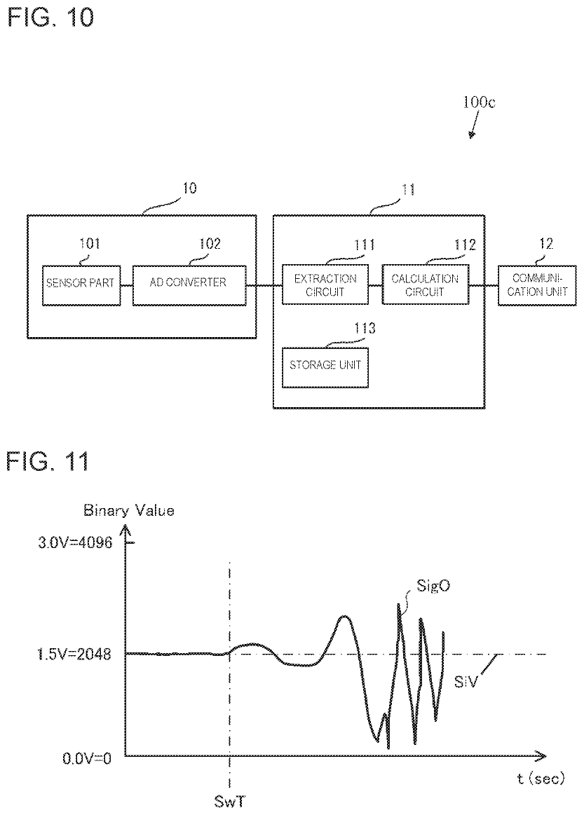

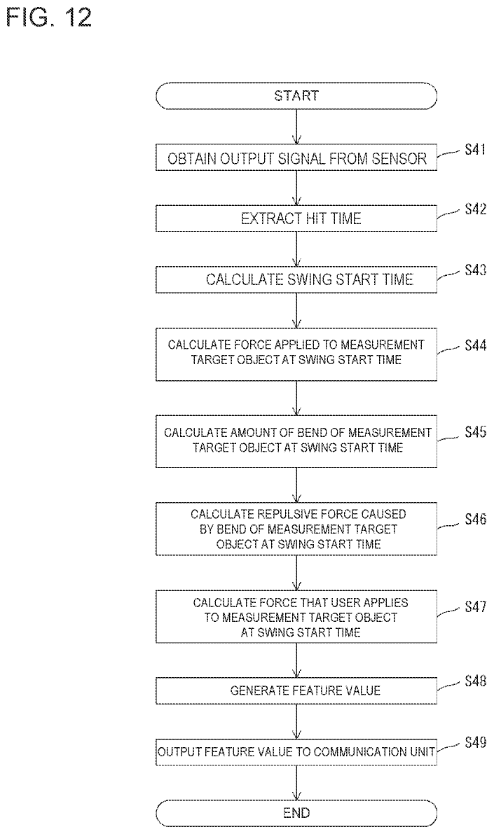

A sensor unit 100c according to a fourth embodiment of the present disclosure will be described below with reference to the figures. FIG. 10 is a block diagram of the sensor unit 100c according to the fourth embodiment. FIG. 11 is a diagram illustrating an example of the output signal SigO that the AD converter 102 outputs to the feature value generation circuit 11 according to the fourth embodiment. FIG. 12 is a flowchart illustrating a process performed by the feature value generation circuit 11 according to the fourth embodiment. Regarding the sensor unit 100c according to the fourth embodiment, a description of only the differences from the sensor unit 100a according to the second embodiment will be given and a description of the rest will be omitted.

The sensor unit 100c is different from the sensor unit 100a in that the sensor unit 100c includes a storage unit 113 (e.g., a storage medium) as illustrated in FIG. 10.

The sensor unit 100c includes the storage unit 113. In this embodiment, the feature value generation circuit 11 calculates a force (first force) FO1 that the user applies to the measurement target object 1 at the specific time, on the basis of the output signal SigO, a first mass m1 of the measurement target object 1, and an elastic modulus k of the measurement target object 1. The feature value F includes the force (first force) FO1 that the user applies to the measurement target object 1 at the specific time.

The first mass m1 of the measurement target object 1 and the elastic modulus k of the measurement target object 1 are inputted in advance to the storage unit 113. The storage unit 113 stores the first mass m1 of the measurement target object 1 and the elastic modulus k of the measurement target object 1.

A value obtained by integrating the derivative value of the amount of deformation of the measurement target object 1 in the rightward-leftward direction with the time is proportional to the acceleration of the measurement target object 1 in the rightward-leftward direction at the specific time. That is, the output signal SigO indirectly indicates a swing acceleration SwA of the measurement target object 1 at the specific time. The force F1 applied to the measurement target object 1 at the specific time can be calculated by multiplying the first mass m1 of the measurement target object 1 by the swing acceleration SwA of the measurement target object 1 at the specific time. As described above, the measurement target object 1 becomes elastically deformed. When the measurement target object 1 becomes elastically deformed, the measurement target object 1 is subjected to a repulsive force in a direction opposite to the direction in which the measurement target object 1 becomes elastically deformed. A repulsive force F2 caused by a bend of the measurement target object 1 at the specific time can be calculated by multiplying the amount of deformation of the measurement target object 1 at the specific time by the elastic modulus k of the measurement target object 1. The sum of the force F1 applied to the measurement target object 1 at the specific time and the repulsive force F2 caused by the bend of the measurement target object 1 at the specific time is the force FO1 that the user applies to the measurement target object 1 at the specific time. Therefore, the feature value generation circuit 11 can calculate the force (first force) FO1 that the user applies to the measurement target object 1 at the swing start time SwT, on the basis of the output signal SigO, the first mass m1 of the measurement target object 1, and the elastic modulus k of the measurement target object 1.

The extraction circuit 111 and the calculation circuit 112 store a program for a process of calculating the force FO1 that the user applies to the measurement target object 1 at the swing start time SwT on the basis of the output signal SigO. A process performed in the feature value generation circuit 11 in relation to calculation of the force FO1 that the user applies to the measurement target object 1 at the swing start time SwT will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S41 in FIG. 12).

Next, the extraction circuit 111 extracts the hit time InT (step S42 in FIG. 12).

Next, the calculation circuit 112 calculates the swing start time SwT on the basis of the output signal SigO (step S43 in FIG. 12).

Next, the calculation circuit 112 calculates the force F1 applied to the measurement target object 1 at the swing start time SwT on the basis of the output signal SigO and the first mass m1 of the measurement target object 1 (step S44 in FIG. 12). More specifically, the calculation circuit 112 calculates the swing acceleration SwA at the swing start time SwT by integrating the value DV, which is the result of subtracting the reference value SiV from the output signal SigO, with a period from the time when the sensor 10 starts detection to the swing start time SwT. The calculation circuit 112 calculates the force F1 applied to the measurement target object 1 at the swing start time SwT by multiplying the swing acceleration SwA by the first mass m1 of the measurement target object 1.

Next, the calculation circuit 112 calculates the amount of bend B of the measurement target object 1 in the rightward-leftward direction at the swing start time SwT on the basis of the output signal SigO (step S45 in FIG. 12). More specifically, the calculation circuit 112 calculates the amount of bend B of the measurement target object 1 in the rightward-leftward direction at the swing start time SwT by integrating the value DV, which is the result of subtracting the reference value SiV from the output signal SigO, with the period from the time when the sensor 10 starts detection of the swing start time SwT to the swing start time SwT.

Next, the calculation circuit 112 calculates, on the basis of the amount of bend B of the measurement target object 1 in the rightward-leftward direction at the swing start time SwT, the repulsive force F2 caused by the bend of the measurement target object 1 at the swing start time SwT (step S46 in FIG. 12). More specifically, the calculation circuit 112 calculates the repulsive force F2 caused by the bend of the measurement target object 1 at the swing start time SwT by multiplying the amount of bend B of the measurement target object 1 in the rightward-leftward direction at the swing start time SwT by the elastic modulus k of the measurement target object 1.

Next, the calculation circuit 112 calculates the force F01 that the user applies to the measurement target object 1 at the swing start time SwT, on the basis of the force F1 applied to the measurement target object 1 at the swing start time SwT and the repulsive force F2 caused by the bend of the measurement target object 1 at the swing start time SwT (step S47 in FIG. 12). More specifically, the calculation circuit 112 assumes the sum of the force F1 applied to the measurement target object 1 at the swing start time SwT and the repulsive force F2 caused by the bend of the measurement target object 1 at the swing start time SwT to be the force FO1 that the user applies to the measurement target object 1 at the swing start time SwT.

Next, the feature value generation circuit 11 generates the feature value F on the basis of the force FO1 that the user applies to the measurement target object 1 at the swing start time SwT, the force FO1 being calculated by the calculation circuit 112 (step S48 in FIG. 12).

Next, the feature value generation circuit 11 outputs the feature value F to the communication unit 12 (step S49 in FIG. 12).

The sensor unit 100c as described above also attains an effect that is the same as the effect attained by the sensor unit 100a. In the sensor unit 100c, the feature value generation circuit 11 calculates the force FO1 that the user applies to the measurement target object 1 at the specific time, on the basis of the output signal SigO, the first mass m1 of the measurement target object 1, and the elastic modulus k of the measurement target object 1. The feature value F includes the force F01 that the user applies to the measurement target object 1 at the specific time. As a result, the sensor unit 100c can transmit the force F01 that the user applies to the measurement target object 1 at the specific time to an external device.

### Fifth Embodiment

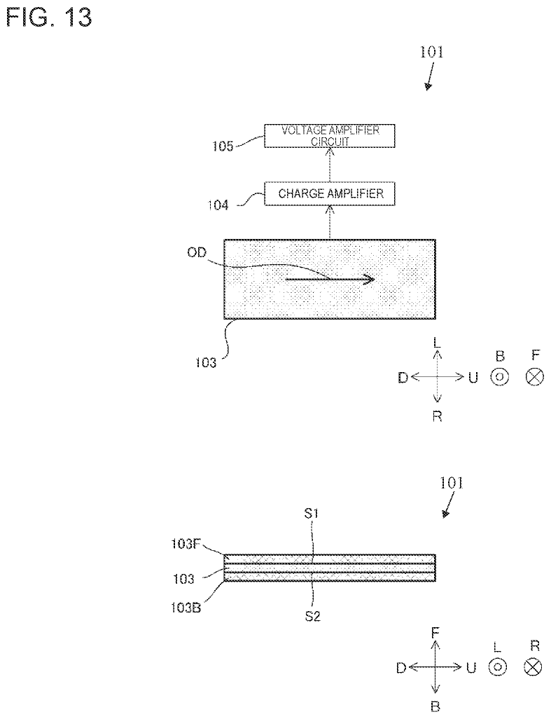

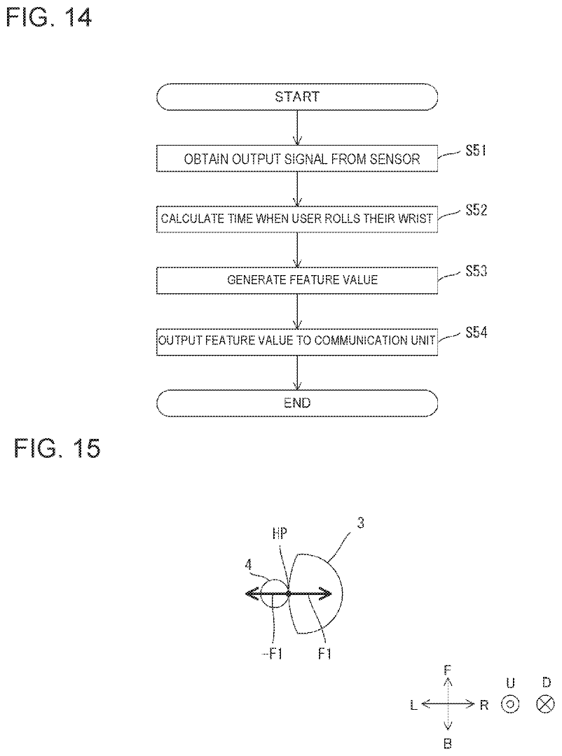

A sensor unit 100d according to a fifth embodiment of the present disclosure will be described below with reference to the figures. FIG. 13 includes a top view and a cross-sectional view of the sensor 10 according to the fifth embodiment. FIG. 14 is a flowchart illustrating a process performed by the feature value generation circuit 11 according to the fifth embodiment. Regarding the sensor unit 100d according to the fifth embodiment, a description of only the differences from the sensor unit 100 according to the first embodiment will be given and a description of the rest will be omitted.

The sensor unit 100d is different from the sensor unit 100 in that as illustrated in FIG. 13, the uniaxial stretching axis OD of the piezoelectric film 103 does not form an angle of 45 degrees counterclockwise relative to the upward-downward direction and does not form an angle of 45 degrees clockwise relative to the rightward-leftward direction.

In this embodiment, the uniaxial stretching axis OD of the piezoelectric film 103 forms an angle of 0 degrees counterclockwise relative to the upward-downward direction and forms an angle of 90 degrees clockwise relative to the rightward-leftward direction. The angle of 0 degrees includes, for example, an angle of about 0 degrees ±10 degrees, and the angle of 90 degrees includes, for example, an angle of about 90 degrees ±10 degrees. Accordingly, the sensor part 101 can make a direction in which the piezoelectric film 103 exhibits the highest piezoelectricity correspond to the direction of twisting about the upward-downward direction. In this embodiment, the sensor 10 detects twisting of the measurement target object 1 about the upward-downward direction (first direction). Accordingly, the output signal SigO has a value corresponding to the derivative value of the amount of twisting T of the measurement target object 1 about the upward-downward direction.

In this embodiment, the feature value generation circuit 11 calculates a time RWT when the user rolls their wrist, on the basis of the output signal SigO. The feature value F includes the time RWT when the user rolls their wrist.

The output signal SigO indirectly indicates a force applied to the measurement target object 1 about the upward-downward direction when the user swings the measurement target object 1. Accordingly, the time RWT when the user rolls their wrist can be calculated on the basis of the output signal SigO. For example, during a period in which the user does not roll their wrist, twisting of the measurement target object 1 about the upward-downward direction does not occur, and the amount of twisting T of the measurement target object 1 about the upward-downward direction is small. In contrast, when the user rolls their wrist, twisting of the measurement target object 1 about the upward-downward direction occurs, and the amount of twisting T of the measurement target object 1 about the upward-downward direction increases. That is, the feature value generation circuit 11 can presume that the time RWT when the user rolls their wrist is included in a period in which the absolute value of a value obtained by integrating the value DV, which is the result of subtracting the reference value SiV from the output signal SigO, with the time increases.

The extraction circuit 111 and the calculation circuit 112 store a program for a process of calculating the time RWT when the user rolls their wrist on the basis of the output signal SigO. A process performed in the feature value generation circuit 11 in relation to calculation of the time RWT when the user rolls their wrist will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S51 in FIG. 14).

Next, the calculation circuit 112 calculates the time RWT when the user rolls their wrist, on the basis of the output signal SigO (step S52 in FIG. 14). More specifically, the calculation circuit 112 determines, for example, whether the absolute value of a value obtained by integrating the value DV, which is the result of subtracting the reference value SiV from the output signal SigO, with a period from the time when the sensor 10 starts detection to the specific time is greater than or equal to a first determination value TH1 set in advance. When the absolute value of a value obtained by integrating the value DV, which is the result of subtracting the reference value SiV from the output signal SigO, with the period from the time when the sensor 10 starts detection to the specific time is greater than or equal to the first determination value TH1 at one or more times in a determination period JT set in advance, the calculation circuit 112 determines the earliest time, in the determination period JT, when the absolute value of a value obtained by integrating the value DV, which is the result of subtracting the reference value SiV from the output signal SigO, with the period from the time when the sensor 10 starts detection to the specific time is greater than or equal to the first determination value TH1 to be the time RWT when the user rolls their wrist.

Next, the feature value generation circuit 11 generates the feature value F on the basis of the time RWT when the user rolls their wrist, the time RWT being calculated by the calculation circuit 112 (step S53 in FIG. 14).

Next, the feature value generation circuit 11 outputs the feature value F to the communication unit 12 (step S54 in FIG. 14).

The sensor unit 100d as described above also attains an effect that is the same as the effect attained by the sensor unit 100. In the sensor unit 100d, the sensor 10 detects twisting of the measurement target object 1 about the upward-downward direction. The feature value generation circuit 11 calculates the time RWT when the user rolls their wrist, on the basis of the output signal SigO. The feature value F includes the time RWT when the user rolls their wrist. As a result, the sensor unit 100d can transmit the time RWT when the user rolls their wrist to an external device.

### Sixth Embodiment

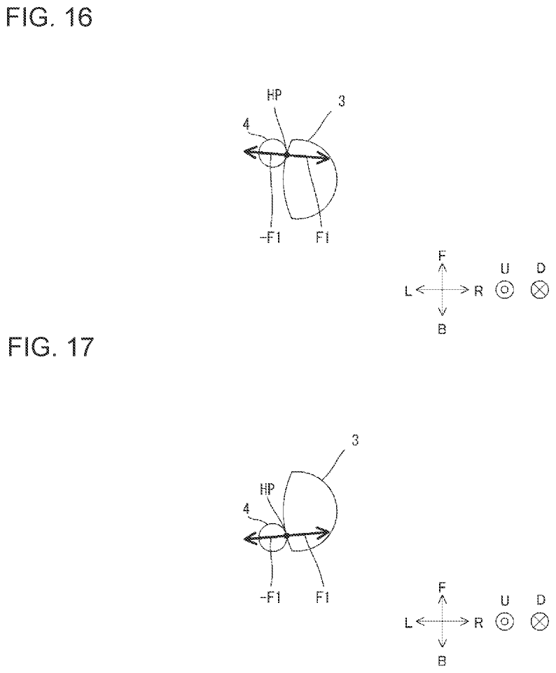

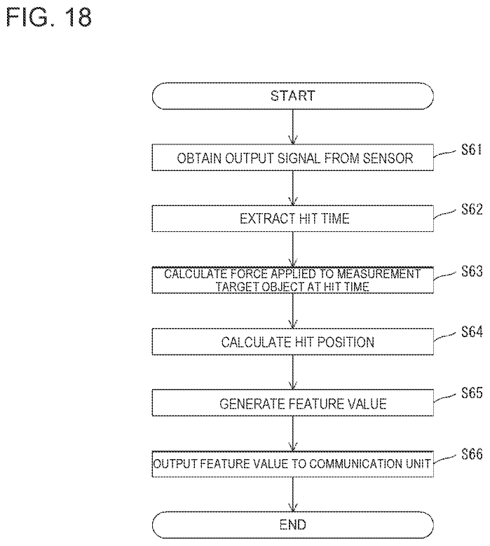

A sensor unit 100e according to a sixth embodiment of the present disclosure will be described below with reference to the figures. FIG. 15 is a plan view of an example of the head 3 of the measurement target object 1 and the hit target object 4 at the hit time InT according to the sixth embodiment. FIG. 16 is a plan view of an example of the head 3 of the measurement target object 1 and the hit target object 4 at the hit time InT according to the sixth embodiment. FIG. 17 is a plan view of an example of the head 3 of the measurement target object 1 and the hit target object 4 at the hit time InT according to the sixth embodiment. FIG. 18 is a flowchart illustrating a process performed by the feature value generation circuit 11 according to the sixth embodiment. Regarding the sensor unit 100e according to the sixth embodiment, a description of only the differences from the sensor unit 100c according to the fourth embodiment will be given and a description of the rest will be omitted.

In this embodiment, the feature value generation circuit 11 calculates a hit position HP at which the measurement target object 1 hits the hit target object 4, on the basis of the output signal SigO and the first mass m1 of the measurement target object 1. The feature value F includes the hit position HP.

As described above, the output signal SigO indirectly indicates a force applied to the measurement target object 1 when the user swings the measurement target object 1. Accordingly, the hit position HP can be calculated on the basis of the output signal SigO. For example, as illustrated in FIG. 15, when the measurement target object 1 hits the hit target object 4 at the center of the face of the head 3 when viewed in the upward-downward direction, the direction of the force F1 applied to the measurement target object 1 at the hit time InT is parallel to the rightward-leftward direction. For example, as illustrated in FIG. 16, when the measurement target object 1 hits the hit target object 4 at a point farther than the center of the face of the head 3 when viewed in the upward-downward direction, the direction of the force F1 applied to the measurement target object 1 at the hit time InT is between the rightward direction and the back direction. At this time, the measurement target object 1 becomes twisted clockwise about the upward-downward direction. Accordingly, the value DV, which is the result of subtracting the reference value SiV from the output signal SigO, becomes a positive value. For example, as illustrated in FIG. 17, when the measurement target object 1 hits the hit target object 4 at a point nearer than the center of the face of the head 3 when viewed in the upward-downward direction, the direction of the force F1 applied to the measurement target object 1 at the hit time InT is between the rightward direction and the front direction. At this time, the measurement target object 1 becomes twisted counterclockwise about the upward-downward direction. Accordingly, the value DV, which is the result of subtracting the reference value SiV from the output signal SigO, becomes a negative value. Accordingly, the hit position HP can be calculated on the basis of the output signal SigO. In other words, the feature value generation circuit 11 can calculate the hit position HP on the basis of whether the value DV, which is the result of subtracting the reference value SiV from the output signal SigO, is a positive value or a negative value.

The extraction circuit 111 and the calculation circuit 112 store a program for a process of calculating the hit position HP on the basis of the output signal SigO. A process performed in the feature value generation circuit 11 in relation to calculation of the hit position HP will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S61 in FIG. 18).

Next, the extraction circuit 111 extracts the hit time InT (step S62 in FIG. 18).

Next, the calculation circuit 112 calculates the force F1 applied to the measurement target object 1 at the hit time InT, on the basis of the output signal SigO and the first mass m1 of the measurement target object 1 (step S63 in FIG. 18).

Next, the calculation circuit 112 calculates the hit position HP on the basis of the output signal SigO and the first mass m1 of the measurement target object 1 (step S64 in FIG. 18).

Next, the feature value generation circuit 11 generates the feature value F on the basis of the hit position HP calculated by the calculation circuit 112 (step S65 in FIG. 18).

Next, the calculation circuit 112 outputs the feature value F to the communication unit 12 (step S66 in FIG. 18).

The sensor unit 100e as described above also attains an effect that is the same as the effect attained by the sensor unit 100c. In the sensor unit 100e, the feature value generation circuit 11 calculates the hit position HP at which the measurement target object 1 hits the hit target object 4, on the basis of the output signal SigO and the first mass m1 of the measurement target object 1. The feature value F includes the hit position HP. As a result, the sensor unit 100e can transmit the hit position HP to an external device.

Note that the sensor 10 may detect twisting of the measurement target object 1 about the upward-downward direction. The sensor 10 may detect a plurality of directions in which the measurement target object 1 becomes deformed. In these cases, the feature value generation circuit 11 can calculate the hit position HP at which the measurement target object 1 hits the hit target object 4 with a higher accuracy.

### Seventh Embodiment

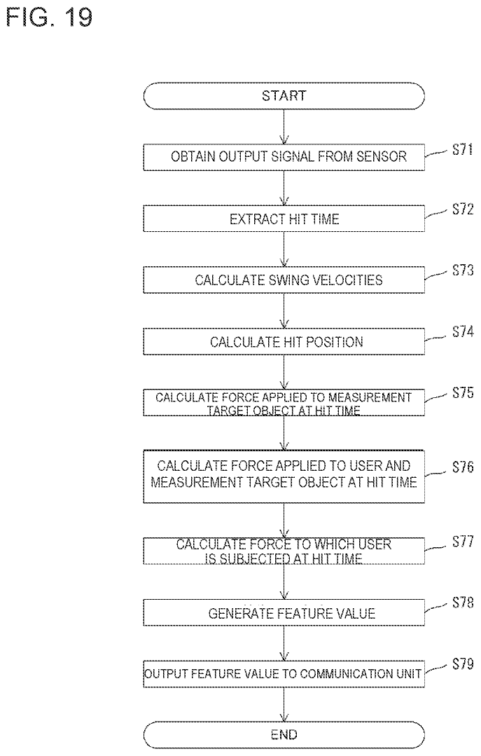

A sensor unit 100f according to a seventh embodiment of the present disclosure will be described below with reference to the figure. FIG. 19 is a flowchart illustrating a process performed by the feature value generation circuit 11 according to the seventh embodiment. Regarding the sensor unit 100f according to the seventh embodiment, a description of only the differences from the sensor unit 100c according to the fourth embodiment will be given and a description of the rest will be omitted.

In this embodiment, the feature value generation circuit 11 extracts the hit time InT on the basis of the output signal SigO. The feature value generation circuit 11 calculates the swing velocity SwV at the hit time InT on the basis of the output signal SigO. The feature value generation circuit 11 calculates a force (second force) F02 to which the user is subjected at the hit time InT, on the basis of the output signal SigO, the swing velocity SwV at the hit time InT, the hit position HP, and the first mass m1 of the measurement target object 1. The feature value F includes the force (second force) F02 to which the user is subjected at the hit time InT.

As described above, the force F1 applied to the measurement target object 1 at the hit time InT can be calculated on the basis of the output signal SigO and the first mass m1 of the measurement target object 1. A force F3 applied to the user and the measurement target object 1 at the hit time InT can be calculated on the basis of the swing velocity SwV at the hit time InT, the hit position HP, and the first mass m1 of the measurement target object 1. More specifically, for example, an impulse that the user and the measurement target object 1 apply to the hit target object 4 during a period from the hit time InT to a time InT+ΔT, which is the time later than the hit time InT by a very short time ΔT, can be regarded as being equal to the product of the force F3 applied to the user and the measurement target object 1 at the hit time InT and ΔT. This impulse can be regarded as being equal to the product of the difference between the swing velocity SwV at the hit time InT and a swing velocity SwV2 at the time InT+ΔT, which is the time later than the hit time InT by the very short time ΔT, and the first mass m1 of the measurement target object 1. Accordingly, the feature value generation circuit 11 can assume the difference between the force F3 applied to the user and the measurement target object 1 at the hit time InT and the force F1 applied to the measurement target object 1 at the hit time InT to be the force F02 to which the user is subjected at the hit time InT.

The extraction circuit 111 and the calculation circuit 112 store a program for a process of extracting the hit time InT on the basis of the output signal SigO, calculating the swing velocity SwV at the hit time InT on the basis of the output signal SigO, and calculating the force F02 to which the user is subjected at the hit time InT, on the basis of the output signal SigO, the swing velocity SwV at the hit time InT, the hit position HP, and the first mass m1 of the measurement target object 1. A process performed in the feature value generation circuit 11 in relation to calculation of the force F02 to which the user is subjected at the hit time InT will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S71 in FIG. 19).

Next, the extraction circuit 111 extracts the hit time InT (step S72 in FIG. 19).

Next, the calculation circuit 112 calculates the swing velocity SwV at the hit time InT and the swing velocity SwV2 at the time InT+ΔT, which is the time later than the hit time InT by the very short time ΔT, on the basis of the output signal SigO (step S73 in FIG. 19).

Next, the calculation circuit 112 calculates the hit position HP on the basis of the output signal SigO and the first mass m1 of the measurement target object 1 (step S74 in FIG. 19).

Next, the calculation circuit 112 calculates the force F1 applied to the measurement target object 1 at the hit time InT on the basis of the output signal SigO and the first mass m1 of the measurement target object 1 (step S75 in FIG. 19).

Next, the calculation circuit 112 calculates the force F3 applied to the user and the measurement target object 1 at the hit time InT on the basis of the swing velocity SwV at the hit time InT, the swing velocity SwV2 at the time InT+ΔT, which is the time later than the hit time InT by the very short time ΔT, the first mass m1 of the measurement target object 1, the very short time ΔT, and the hit position HP (step S76 in FIG. 19).

Next, the calculation circuit 112 calculates the force F02 to which the user is subjected at the hit time InT (step S77 in FIG. 19). More specifically, the calculation circuit 112 assumes, for example, the difference between the force F3 applied to the user and the measurement target object 1 at the hit time InT and the force F1 applied to the measurement target object 1 at the hit time InT to be the force F02 to which the user is subjected at the hit time InT.

Next, the feature value generation circuit 11 generates the feature value F on the basis of the force F02 to which the user is subjected at the hit time InT, the force F02 being calculated by the calculation circuit 112 (step S78 in FIG. 19).

Next, the calculation circuit 112 outputs the feature value F to the communication unit 12 (step S79 in FIG. 19).

The sensor unit 100f as described above also attains an effect that is the same as the effect attained by the sensor unit 100c. In the sensor unit 100f, the feature value generation circuit 11 extracts the hit time InT on the basis of the output signal SigO. The feature value generation circuit 11 calculates the swing velocity SwV at the hit time InT on the basis of the output signal SigO. The feature value generation circuit 11 calculates the force (second force) F02 to which the user is subjected at the hit time InT, on the basis of the output signal SigO, the swing velocity SwV at the hit time InT, the hit position HP, and the first mass m1 of the measurement target object 1. The feature value F includes the force (second force) F02 to which the user is subjected at the hit time InT. As a result, the sensor unit 100f can transmit the force F02 to which the user is subjected at the hit time InT to an external device.

### Eighth Embodiment

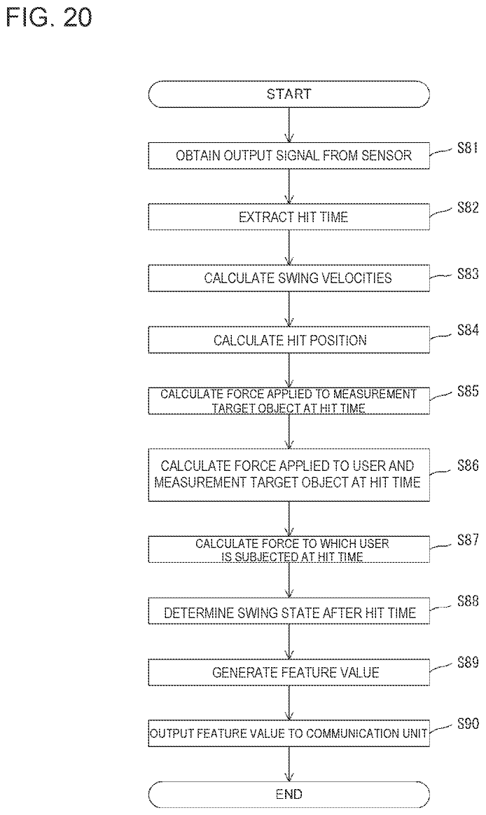

A sensor unit 100g according to an eighth embodiment of the present disclosure will be described below with reference to the figure. FIG. 20 is a flowchart illustrating a process performed by the feature value generation circuit 11 according to the eighth embodiment. Regarding the sensor unit 100g according to the eighth embodiment, a description of only the differences from the sensor unit 100f according to the seventh embodiment will be given and a description of the rest will be omitted.

In this embodiment, the feature value generation circuit 11 determines a swing state after the hit time InT on the basis of the force (second force) F02 to which the user is subjected at the hit time InT. The feature value F includes the result of determination of the swing state after the hit time InT.

As described above, the force F02 to which the user is subjected at the hit time InT can be calculated on the basis of the output signal SigO, the swing velocity SwV at the hit time InT, the hit position HP, and the first mass m1 of the measurement target object 1. For example, when the force F02 to which the user is subjected at the hit time InT is large, it can be presumed that not the measurement target object 1 but the user is subjected to force at the hit time InT. Accordingly, the feature value generation circuit 11 can determine that the follow through after the hit time InT is not completely made, that is, the follow-through state is unsatisfactory. On the other hand, when the force F02 to which the user is subjected at the hit time InT is small, it can be presumed that the measurement target object 1 is successfully subjected to force at the hit time InT. Accordingly, the feature value generation circuit 11 can determine that the follow through after the hit time InT is completely made, that is, the follow-through state is satisfactory.

The extraction circuit 111 and the calculation circuit 112 store a program for a process of determining the swing state after the hit time InT on the basis of the force F02 to which the user is subjected at the hit time InT. A process performed in the feature value generation circuit 11 in relation to determination of the swing state after the hit time InT will be described in detail below. Note that step S81 to step S87 in FIG. 20 are the same as step S71 to step S77 in FIG. 19 respectively, and therefore, a description thereof will be omitted.

The calculation circuit 112 determines the swing state after the hit time InT on the basis of the force F02 to which the user is subjected at the hit time InT (step S88 in FIG. 20). More specifically, the calculation circuit 112 determines, for example, whether the force F02 to which the user is subjected at the hit time InT is greater than or equal to a second determination value TH2 set in advance. When the force F02 to which the user is subjected at the hit time InT is less than TH2, the calculation circuit 112 determines that the swing state after the hit time InT is satisfactory. On the other hand, when the force F02 to which the user is subjected at the hit time InT is greater than or equal to TH2, the calculation circuit 112 determines that the swing state after the hit time InT is unsatisfactory.

Next, the feature value generation circuit 11 generates the feature value F on the basis of the result of determination of the swing state after the hit time InT performed by the calculation circuit 112 (step S89 in FIG. 20).

Next, the feature value generation circuit 11 outputs the feature value F to the communication unit 12 (step S90 in FIG. 20).

The sensor unit 100g as described above also attains an effect that is the same as the effect attained by the sensor unit 100f. The sensor unit 100g determines the swing state after the hit time InT on the basis of the force F02 to which the user is subjected at the hit time InT. The feature value F includes the result of determination of the swing state after the hit time InT. As a result, the sensor unit 100g can transmit the result of determination of the swing state after the hit time InT to an external device.

### Ninth Embodiment

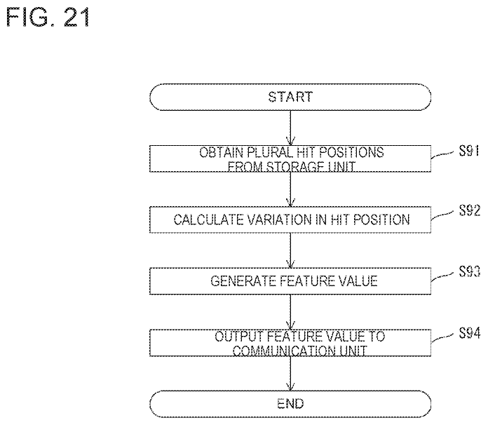

A sensor unit 100h according to a ninth embodiment of the present disclosure will be described below with reference to the figure. FIG. 21 is a flowchart illustrating a process performed by the feature value generation circuit 11 according to the ninth embodiment. Regarding the sensor unit 100h according to the ninth embodiment, a description of only the differences from the sensor unit 100e according to the sixth embodiment will be given and a description of the rest will be omitted.

The sensor unit 100h is different from the sensor unit 100e in that the storage unit 113 stores the feature value F for each swing.

In this embodiment, the feature value F includes the hit positions HP. Accordingly, the storage unit 113 stores the hit position HP upon each swing. The feature value generation circuit 11 calculates a variation Va among a plurality of swings on the basis of the feature value F for each swing. In this embodiment, the feature value generation circuit 11 calculates the variation Va in the hit position HP on the basis of the hit position HP upon each swing. The feature value F includes the variation Va.

The calculation circuit 112 stores a program for a process of calculating the variation Va in the hit position HP on the basis of the hit position HP upon each swing. A process performed in the feature value generation circuit 11 in relation to calculation of the variation Va in the hit position HP will be described in detail below. This process is started in response to the feature value generation circuit 11 obtaining the hit position HP upon each swing from the storage unit 113. Specifically, first, the calculation circuit 112 obtains the hit position HP upon each swing from the storage unit 113 (step S91 in FIG. 21).

Next, the calculation circuit 112 calculates the variation Va in the hit position HP on the basis of the hit position HP upon each swing (step S92 in FIG. 21). More specifically, the calculation circuit 112 calculates, for example, the variance or standard deviation of the hit positions HP.

Next, the feature value generation circuit 11 generates the feature value F on the basis of the variation Va in the hit position HP calculated by the calculation circuit 112 (step S93 in FIG. 21).

Next, the feature value generation circuit 11 outputs the feature value F to the communication unit 12 (step S94 in FIG. 21).

The sensor unit 100h as described above also attains an effect that is the same as the effect attained by the sensor unit 100e. In the sensor unit 100h, the storage unit 113 stores the feature value F for each swing. The feature value generation circuit 11 calculates the variation Va among the plurality of swings on the basis of the feature value F for each swing. The feature value F includes the variation Va among the plurality of swings. As a result, the sensor unit 100h can transmit the variation Va among the plurality of swings to an external device.

### Tenth Embodiment

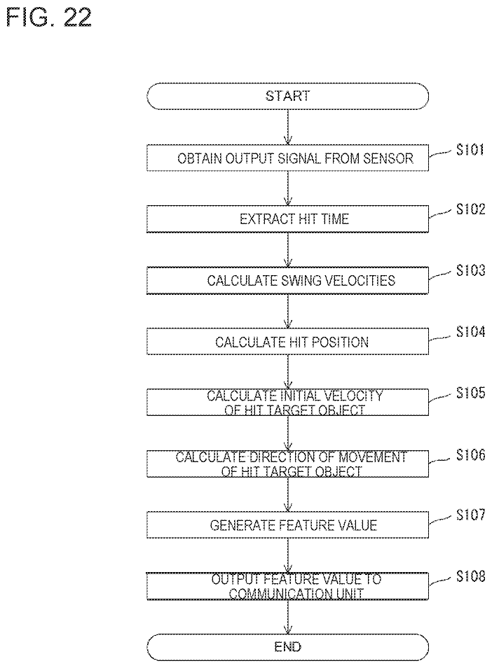

A sensor unit 100i according to a tenth embodiment of the present disclosure will be described below with reference to the figure. FIG. 22 is a flowchart illustrating a process performed by the feature value generation circuit 11 according to the tenth embodiment. Regarding the sensor unit 100i according to the tenth embodiment, a description of only the differences from the sensor unit 100f according to the seventh embodiment will be given and a description of the rest will be omitted.

In this embodiment, the feature value generation circuit 11 extracts the hit time InT on the basis of the output signal SigO. The feature value generation circuit 11 calculates the swing velocity SwV at the hit time InT on the basis of the output signal SigO. The feature value generation circuit 11 calculates an initial velocity v of the hit target object 4 or a direction of movement DM of the hit target object 4 on the basis of the output signal SigO, the swing velocity SwV at the hit time InT, the hit position HP, and a second mass m2 of the hit target object 4. The feature value F includes the initial velocity v of the hit target object 4 or the direction of movement DM of the hit target object 4.

As described above, an impulse that the user and the measurement target object 1 apply to the hit target object 4 during the period from the hit time InT to the time InT+ΔT, which is the time later than the hit time InT by the very short time ΔT, can be regarded as being equal to the product of the force F3 applied to the user and the measurement target object 1 at the hit time InT and ΔT. This impulse can be regarded as being equal to the product of the second mass m2 of the hit target object 4 and the initial velocity v of the hit target object 4. Therefore, the feature value generation circuit 11 can calculate the initial velocity v of the hit target object 4 on the basis of the output signal SigO, the swing velocity SwV at the hit time InT, and the second mass m2 of the hit target object 4. The feature value generation circuit 11 can calculate the direction of movement DM of the hit target object 4 on the basis of the hit position HP and the initial velocity v of the hit target object 4.

The second mass m2 of the hit target object 4 is inputted in advance to the storage unit 113. The storage unit 113 stores the second mass m2 of the hit target object 4.

The extraction circuit 111 and the calculation circuit 112, store a program for a process of extracting the hit time InT on the basis of the output signal SigO, calculating the swing velocity SwV at the hit time InT on the basis of the output signal SigO, and calculating the initial velocity v of the hit target object 4 or the direction of movement DM of the hit target object 4 on the basis of the output signal SigO, the swing velocity SwV at the hit time InT, the hit position HP, and the second mass m2 of the hit target object 4. A process performed in the feature value generation circuit 11 in relation to calculation of the initial velocity v of the hit target object 4 or the direction of movement DM of the hit target object 4 will be described in detail below. This process is started in response to the feature value generation circuit 11 obtaining the output signal SigO from the sensor 10. Specifically, first, the extraction circuit 111 and the calculation circuit 112 obtain the output signal SigO from the sensor 10 (step S101 in FIG. 22).

Next, the extraction circuit 111 extracts the hit time InT (step S102 in FIG. 22).

Next, the calculation circuit 112 calculates the swing velocity SwV at the hit time InT and the swing velocity SwV2 at the time InT+ΔT, which is the time later than the hit time InT by the very short time ΔT, on the basis of the output signal SigO (step S103 in FIG. 22).

Next, the calculation circuit 112 calculates the hit position HP on the basis of the output signal SigO and the first mass m1 of the measurement target object 1 (step S104 in FIG. 22).

Next, the calculation circuit 112 calculates the initial velocity v of the hit target object 4 on the basis of the swing velocity SwV at the hit time InT, the swing velocity SwV2 at the time InT+ΔT, which is the time later than the hit time InT by the very short time ΔT, the first mass m1 of the measurement target object 1, the second mass m2 of the hit target object 4, and the very short time ΔT (step S105 in FIG. 22).

Next, the calculation circuit 112 calculates the direction of movement DM of the hit target object 4 on the basis of the hit position HP and the initial velocity v of the hit target object 4 (step S106 in FIG. 22).

Next, the feature value generation circuit 11 generates the feature value F on the basis of the initial velocity v of the hit target object 4 or the direction of movement DM of the hit target object 4, the initial velocity v and the direction of movement DM being calculated by the calculation circuit 112 (step S107 in FIG. 22).

Next, the calculation circuit 112 outputs the feature value F to the communication unit 12 (step S108 in FIG. 22).

The sensor unit 100i as described above also attains an effect that is the same as the effect attained by the sensor unit 100f. In the sensor unit 100i, the feature value generation circuit 11 extracts the hit time InT on the basis of the output signal SigO. The feature value generation circuit 11 calculates the swing velocity SwV at the hit time InT on the basis of the output signal SigO. The feature value generation circuit 11 calculates the initial velocity v of the hit target object 4 or the direction of movement DM of the hit target object 4 on the basis of the output signal SigO, the swing velocity SwV at the hit time InT, the hit position HP, and the second mass m2 of the hit target object 4. The feature value F includes the initial velocity v of the hit target object 4 or the direction of movement DM of the hit target object 4. As a result, the sensor unit 100i can transmit the initial velocity v of the hit target object 4 or the direction of movement DM of the hit target object 4 to an external device.

Note that the sensor 10 may detect twisting of the measurement target object 1 about the upward-downward direction. The sensor 10 may detect a plurality of directions in which the measurement target object 1 becomes deformed. In these cases, the feature value generation circuit 11 can calculate the initial velocity v of the hit target object 4 or the direction of movement DM of the hit target object 4 with a higher accuracy.

### Other Embodiments

The sensor unit according to the present disclosure is not limited to the sensor units 100 and 100a to 100i and can be changed without departing from the gist of the present disclosure. The configurations of the sensor units 100 and 100a to 100i can be combined as desired.

The measurement target object 1 need not be a member for hitting the hit target object 4.

The measurement target object 1 is not limited to a golf club and may be any of a bat, a racket, a game controller, a fishing rod, a bamboo sword, a robot arm, and so on. In this case, the measurement target object 1 needs to have a portion that becomes deformed when swung.

The measurement target object 1 is not limited to an object that becomes deformed in response to the user swinging the measurement target object 1. The measurement target object 1 may be an object, such as a robot arm, that becomes deformed when the measurement target object itself swings.

The hit target object 4 is not limited to a golf ball and may be any of a baseball, a tennis ball, and so on.

The output signal SigO generated by the sensor 10 need not indicate a relationship between the derivative value of the amount of deformation of the measurement target object 1 and the time. The output signal SigO generated by the sensor 10 may indicate a relationship between a physical quantity related to the amount of deformation of the measurement target object 1 and the time. The physical quantity related to the amount of deformation is, for example, the amount of deformation or a stress.

The sensor 10 may detect the amount of deformation or a stress in the measurement target object 1. The sensor 10 may include, for example, a strain gauge. When the sensor 10 detects the amount of deformation of the measurement target object 1, the feature value generation circuit 11 may extract the amount of bend B of the measurement target object 1 at the specific time on the basis of the output signal SigO generated by the sensor 10.

The piezoelectric film 103 may have a piezoelectric constant of d31. The piezoelectric film 103 having a piezoelectric constant of d31 is, for example, a PVDF (polyvinylidene fluoride) film.

The first main surface S1 and the second main surface S2 need not have a rectangular shape when viewed in a direction normal to the first main surface S1 in a state in which the piezoelectric film 103 is spread on a plane. The rectangular shape includes a rectangular shape and a rectangular shape that becomes slightly deformed. The rectangular shape that becomes slightly deformed is, for example, a round-cornered rectangular shape. The first main surface S1 and the second main surface S2 may have, for example, an elliptic shape or a square shape when viewed in a direction normal to the first main surface S1 in a state in which the piezoelectric film 103 is spread on a plane.

The direction of deformation of the measurement target object 1 detected by the sensor 10 is not limited to the rightward-leftward direction and may be the upward-downward direction, the front-back direction, or any direction. The sensor 10 may detect a plurality of directions in which the measurement target object 1 becomes deformed.

The feature value F generated by the feature value generation circuit 11 performing the extraction process on the basis of the output signal SigO need not include the hit time InT and may include any time or a plurality of times. The specific time may be any time and may include a plurality of times. For example, the specific time may be the time when the output signal SigO indicates the maximum value or may be the time when the output signal SigO indicates the minimum value.

The feature value F generated by the feature value generation circuit 11 performing the extraction process on the basis of the output signal SigO need not include the specific time and may include a value of the output signal SigO at the specific time. For example, the feature value F may include a value of the output signal SigO at the hit time InT.

The external device to which the communication unit 12 transmits the feature value F is not limited to a portable wireless communication terminal, such as a smartphone, and may be a stationary wireless communication terminal, such as a server.

The communication unit 12 may transmit the feature value F to the external device by wired communication instead of wireless communication. Wired communication is, for example, communication of electric signals through a communication line, such as an electric wire or an optical fiber.

The method for extracting the hit time InT, determination of the swing start time SwT, the swing velocity SwV at the specific time, the force FO1 that the user applies to the measurement target object 1 at the specific time, the time RWT when the user rolls their wrist, the hit position HP, the force F02 to which the user is subjected at the hit time InT, and the swing state after the hit time InT, and the method for calculating the variation Va among a plurality of swings and the initial velocity v of the hit target object 4 or the direction of movement DM of the hit target object 4 are not limited to those described above and may be other methods. For example, the feature value generation circuit 11 may extract the hit time InT, determine the swing start time SwT, the swing velocity SwV at the specific time, the force FO1 that the user applies to the measurement target object 1 at the specific time, the time RWT when the user rolls their wrist, the hit position HP, the force F02 to which the user is subjected at the hit time InT, or the swing state after the hit time InT, or calculate the variation Va among a plurality of swings or the initial velocity v of the hit target object 4 or the direction of movement DM of the hit target object 4, on the basis of artificial intelligence, machine learning, deep learning, or the like.

The method for calculating the variation Va among a plurality of swings is not limited to the method of calculating the variance or standard deviation of the feature values F for respective swings and may be another statistical method. The other statistical method may be a method of calculating, for example, the coefficient of variation.

In the sensor unit 100i, the feature value generation circuit 11 may calculate the initial velocity v of the hit target object 4, and the feature value F may include the initial velocity v of the hit target object 4. In the sensor unit 100i, the feature value generation circuit 11 may calculate the direction of movement DM of the hit target object 4, and the feature value F may include the direction of movement DM of the hit target object 4.

The extraction circuit 111 and the calculation circuit 112 need not be a CPU. The extraction circuit 111 or the calculation circuit 112 may be, for example, an MPU (micro-processing unit).

The storage unit 113 need not include the ROM. The storage unit 113 may include, for example, a flash memory instead of the ROM.

The charge amplifier 104 need not convert the charge to a voltage value within a range of 0.0 V to 3.0 V. The charge amplifier 104 may convert the charge to a voltage value within, for example, a range of 0.0 V to 1.5 V or a range of 0.0 V to 5.0 V.

The resolution of the AD converter 102 is not limited to 12 bits and may be a bit value other than 12 bits. The resolution of the AD converter 102 may be, for example, 10 bits or 16 bits.

The shape of the measurement target object 1 need not be a shape extending in the upward-downward direction.

The feature value generation circuit 11 need not be attached to the measurement target object 1.
1 measurement target object
2 shaft
3 head
4 hit target object
10 sensor
11 feature value generation circuit
12 communication unit
100, 100a to 100i sensor unit
101 sensor part
102 AD converter
103 piezoelectric film
103F first electrode
103B second electrode
104 charge amplifier
105 voltage amplifier circuit
111 extraction circuit
112 calculation circuit
113 storage unit
DM direction of movement
DSwT downswing start time
F feature value
FO1, FO2, F1 to F3, FRL1 force
HP hit position
InT hit time
JT determination period
OD uniaxial stretching axis
RE reference time
S1 first main surface
S2 second main surface
SiV reference value
SigD detection signal
SigO output signal
SwA swing acceleration
SwT swing start time
SwV swing velocity
T1 first period
T2 second period
T3 third period
TH1 first determination value
TH2 second determination value
Va variation
k elastic modulus
m1 first mass
m2 second mass
v initial velocity

1. A sensor unit comprising:
a sensor that is attached to a measurement target object that deforms in response to being swung by a user, the sensor being configured to generate an output signal indicating a relationship between time and a physical quantity related to an amount of deformation of the measurement target object;
a feature value generation circuit comprising a storage medium configured to store a first mass of the measurement target object and an elastic modulus of the measurement target object, the feature value generation circuit being configured to:
calculate a first force that the user applies to the measurement target object at a specific time, on the basis of the output signal, the first mass, and the elastic modulus; and
generate a feature value on the basis of the output signal, the feature value being a parameter indicating a feature of the swing and including the first force at the specific time; and
a transmitter that is attached to the measurement target object and that is configured to transmit the feature value to an external device by wireless communication or wired communication.

2. The sensor unit according to claim 1, wherein the feature value generation circuit is configured to generate the feature value by performing an extraction process on the basis of the output signal.

3. The sensor unit according to claim 2,
wherein the measurement target object is a member for hitting a hit target object,
wherein the feature value generation circuit is configured to extract a hit time when the measurement target object hits the hit target object, on the basis of the output signal, and
wherein the feature value further includes the hit time.

4. The sensor unit according to claim 1,
wherein the feature value generation circuit is further configured to calculate an amount of bend of the measurement target object at the specific time on the basis of the output signal, and
wherein the feature value includes the amount of bend of the measurement target object at the specific time.

5. The sensor unit according to claim 1,
wherein the feature value generation circuit is further configured to calculate a swing start time on the basis of the output signal, and
wherein the feature value further includes the swing start time.

6. The sensor unit according to claim 1,
wherein the feature value generation circuit is further configured to calculate a swing velocity at the specific time on the basis of the output signal, and
wherein the feature value further includes the swing velocity at the specific time.

7. The sensor unit according to claim 1,
wherein a shape of the measurement target object extends in a first direction,
wherein the sensor is configured to detect twisting of the measurement target object about the first direction,
wherein the feature value generation circuit is further configured to calculate a time when the user rolls a wrist of the user, on the basis of the output signal, and
wherein the feature value further includes the time when the user rolls the wrist.

8. The sensor unit according to claim 1,
wherein the measurement target object is a member for hitting a hit target object,
wherein the feature value generation circuit is further configured to calculate a hit position at which the measurement target object hits the hit target object, on the basis of the output signal and the first mass, and
wherein the feature value further includes the hit position.

9. The sensor unit according to claim 8,
wherein the feature value generation circuit is further configured to:
extract a hit time when the measurement target object hits the hit target object, on the basis of the output signal;
calculate a swing velocity at the hit time; and
calculate a second force to which the user is subjected at the hit time, on the basis of the output signal, the swing velocity, the hit position, and the first mass, and
wherein the feature value further includes the second force at the hit time.

10. The sensor unit according to claim 9,
wherein the feature value generation circuit is further configured to determine a state of the swing after the hit time on the basis of the output signal and the second force at the hit time, and
wherein the feature value further includes a result of the determination.

11. The sensor unit according to claim 8,
wherein the storage medium is further configured to store a second mass of the hit target object,
wherein the feature value generation circuit is further configured to:
extract a hit time when the measurement target object hits the hit target object, on the basis of the output signal;
calculate a swing velocity at the hit time; and
calculate an initial velocity of the hit target object or a direction of movement of the hit target object on the basis of the output signal, the swing velocity at the hit time, the hit position, and the second mass, and
wherein the feature value further includes the initial velocity or the direction of movement.

12. The sensor unit according to claim 1,
wherein the storage medium is further configured to store a feature value for each of a plurality of different swings,
wherein the feature value generation circuit is further configured to calculate, on the basis of the plurality of feature values, a variation among the plurality of different swings, and
wherein the feature value further includes the variation.

13. The sensor unit according to claim 1, wherein a shape of the measurement target object extends in a first direction.

14. The sensor unit according to claim 1, wherein the feature value generation circuit is attached to the measurement target object.

15. The sensor unit according to claim 1, wherein the measurement target object is a golf club, a bat, a racket, or a game controller.

16. The sensor unit according to claim 1, wherein the feature value has less data than the output signal.
